(19) United States
(12) Patent Application Publication
(10) Pub. No.: US 2006/0249228 A1
(43) Pub. Date: Nov. 9, 2006

(54) Dovetail jig

(75) Inventors: David R. Hout, Clinton, OH (US); W. Jason Bare, Uniontown, OH (US)

Correspondence Address: SAND & SEBOLT, AEGIS TOWER, SUITE 1100, 4940 MUNSON STREET, NW, CANTON, OH, 44718-3615, US

(73) Assignee: HART DESIGN, INC., Hartville, OH (US)

(21) Appl. No.: 11/123,259

(22) Filed: May 6, 2005

(51) Int. Cl. B27C 5/00; B27F 7/00; B27D 1/00

(52) U.S. Cl. 144/144.1; 144/344; 144/144.51

(57) ABSTRACT

A dovetail jig has a frame with a plurality of longitudinally and axially positionable guide fingers mounted thereon each having straight and tapered guide surfaces used in forming dovetails and pins in respective workpieces. Spacers interlockingly fit in slots formed in the guide fingers to set spacing between adjacent guide fingers. A stop includes a first stop member having a first positioning surface positionable at a first location for positioning a first workpiece and a second stop member having a second positioning surface positionable at a second location for positioning a second workpiece. Preferably, the second stop member defines a hole in which the first stop member is received to mount the second stop member on the first stop member. A workpiece-securing mechanism includes a camming bar and an L-shaped clamp member which serves as a cover to prevent workpiece shavings from clogging the camming engagement between the two.

### BACKGROUND OF THE INVENTION

1. Technical Field

The invention relates generally to a jig for cutting workpieces such as boards to form joints such as a dovetail joint between a pair of workpieces. More particularly, the invention relates to such a jig having a plurality of guide fingers for guiding a cutting apparatus during the cutting of the workpieces wherein the spacing between the guide fingers is adjustable. Specifically, the invention relates to such a jig wherein unique spacers are used to set the distance between adjacent guide fingers.

2. Background Information

Dovetail jigs and similar jigs for cutting joint members are well known and include those which use a solid template having fixed guide fingers, as well as those having a plurality of longitudinally moveable guide fingers which allow infinite adjustment of spacing between the guide fingers, such as U.S. Pat. No. 4,428,408 to Grisley. As is well known in the art, templates formed of solid plates or a plurality of fingers include straight guide surfaces extending outwardly in an axial direction for guiding a cutting apparatus such as a router to cut a first workpiece to form dovetails and tapered guide surfaces for guiding the router in cutting a second workpiece to form pins of a mating configuration with the dovetails. The templates which include a plurality of guide fingers provide the distinct advantage of adjusting the spacing between the fingers to vary the size of the pins or dovetails and the gaps therebetween as desired. However, there is room for improvement with regard to templates utilizing such adjustable guide fingers.

Setting the spacing between the various fingers of such templates requires measurements between the fingers to ensure the desired spacing and associated size of the dovetails and pins. Such measurements can be relatively painstaking and time consuming. While spacers are known in the art (see Grisley), there remains room for improvement in order to quickly and surely secure the spacing between an adjacent pair of such guide fingers.

In addition, stops mounted on the frame of a jig are used in the positioning of the workpiece thereon. When the guide fingers extend in a single direction with the straight and tapered guide surfaces thereon for the formation of dovetails and pins on respective workpieces, it is necessary to adjust the position of the respective workpieces so that the dovetails and pins are properly aligned on each workpiece. While adjustable stops are known in the art, there is still room for improvement in this area to facilitate the positioning of the respective workpieces on the jig.

Moreover, the securing or clamping mechanisms for securing a workpiece to the jig while being cut sometimes use a camming bar in order to quickly lock the workpiece into place. However, shavings from the cutting process tend to collect between the camming member and a clamp bar and thus interfere with the proper camming engagement between these two members.

The present invention solves these problems with a variety of unique features which facilitate the formation of joint members such as dovetails and pins.

### BRIEF SUMMARY OF THE INVENTION

The present invention provides a jig used for cutting joint members in workpieces, comprising a frame having axial and longitudinal directions and adapted to selectively secure the workpieces to be cut; a plurality of guide fingers elongated in the axial direction; each guide finger having guide surfaces adapted to guide a cutter in the formation of the joint members; the guide fingers being selectively positionable in the longitudinal direction; and a spacer selectively mountable on a first pair of adjacent fingers to selectively fix the adjacent fingers in the longitudinal direction with respect to one another, thereby setting longitudinal spacing between the first and second fingers.

The present invention also provides a method comprising the steps of securing a first workpiece to a frame having axial and longitudinal directions; positioning a plurality of axially-elongated guide fingers in the longitudinal direction; fixing a first adjacent pair of the guide fingers in the longitudinal direction with respect to one another with a spacer, the first adjacent pair including first and second guide fingers; securing the plurality of guide fingers with respect to the frame; and guiding a cutter with the guide fingers to cut the first workpiece.

### BRIEF DESCRIPTION OF THE SEVERAL VIEWS OF THE DRAWINGS

FIG. 1 is a perspective view of the dovetail jig of the present invention.

FIG. 2A is an enlarged perspective view of the spacer of the present invention.

FIG. 2B is an enlarged perspective view of a pair of the guide fingers of the present invention.

FIG. 3 is a perspective view of a dovetail joint formed by a pair of workpieces.

FIG. 4 is an exploded view of the dovetail joint of FIG. 2 showing the workpieces separately.

FIG. 5 is a perspective view similar to FIG. 1 showing a first workpiece in the process of being positioned for the cutting of dovetails.

FIG. 6 is an enlarged view similar to the encircled portion of FIG. 5 showing the spacer in the process of being inserted into slots formed in an adjacent pair of the guide fingers.

FIG. 7 is an enlarged view of the encircled portion of FIG. 5 showing the spacer inserted in the slots.

FIG. 8 is a perspective view similar to FIG. 5 with the first workpiece positioned against the first stop member for the cutting of the dovetails with the lower securing mechanism in the locked position.

FIG. 8A is an enlarged fragmentary sectional view taken on line 8A-8A of FIG. 8 showing the camming engagement between the camming member and clamping member of the workpiece securing mechanism.

FIG. 9 is an enlarged fragmentary front elevational view of the jig showing a router cutting gaps in the first workpiece to form the dovetails.

FIG. 10 is a perspective view similar to FIG. 8 showing the first workpiece being removed and the finger-mounting assembly being removed from the frame of the jig for repositioning.

FIG. 11 is similar to FIG. 10 and shows a pair of spacers being moved and the finger-mounting assembly being repositioned on the frame on the other side of the moved spacers.

FIG. 12 is an enlarged fragmentary perspective view of the guide fingers mounted on the guide bars of the finger-mounting assembly with the spacer being removed from the slots of an adjacent pair of guide fingers.

FIG. 13 is similar to FIG. 12 and shows one of the fingers of the adjacent pair being moved along the guide bars and the spacer being inserted into a second pair of slots, one of which is on the moved guide finger and another of which is on a different guide finger in order to set the spacing between this second pair of adjacent guide fingers.

FIG. 14 is a fragmentary top plan view of the guide fingers shown in FIG. 13 showing the spacer positioned in the second pair of slots in preparation for cutting the second workpiece to form pins thereon.

FIG. 15 is similar to FIG. 11 and shows the new position of the spacer in the second pair of slots with the annular second stop member being positioned over the first stop member and the second workpiece being moved into position.

FIG. 16 is similar to FIG. 15 and shows the second workpiece secured in position against the second stop member for cutting of the second workpiece to form the pins thereon.

FIG. 17 is a fragmentary front elevational view of the jig shown in FIG. 16 showing the router cutting the gaps between the pins on the second workpiece.

FIG. 18 is similar to FIG. 16 and shows the second workpiece with pins cut therein being removed from the jig.

Similar numbers refer to similar parts throughout the specification.

### DETAILED DESCRIPTION OF THE INVENTION

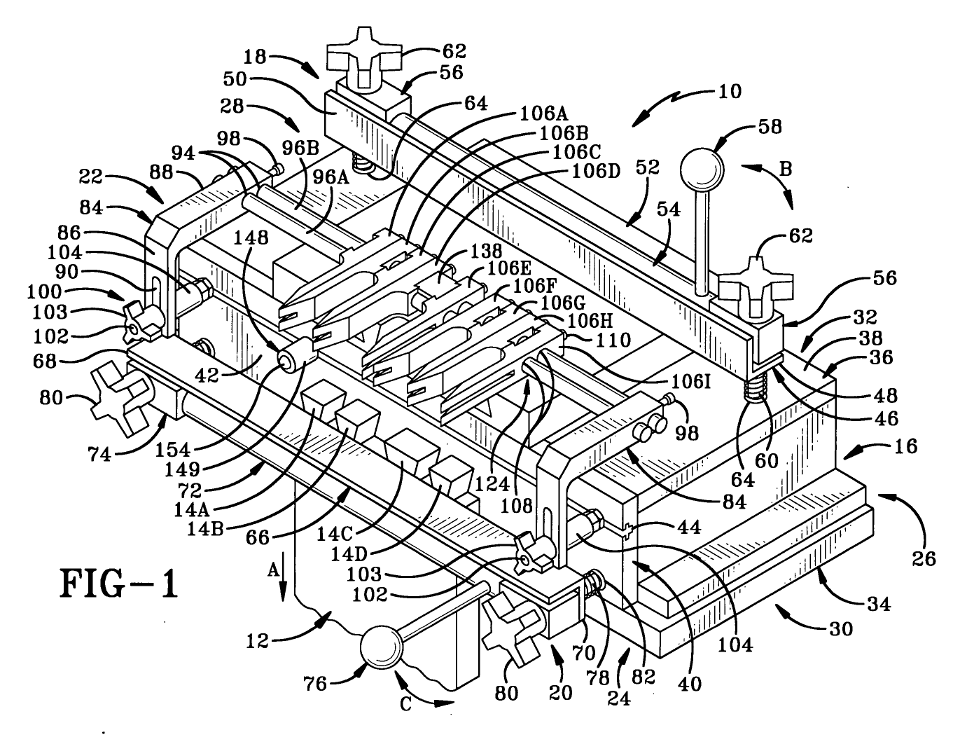

The dovetail jig of the present invention is indicated generally at 10 in FIG. 1. Jig 10 is used in the cutting of workpieces to form dovetail joints and shows a first workpiece 12 being removed from jig 10 as indicated by Arrow A in FIG. 1 after workpiece 12 has been cut to form dovetails 14A-D thereon. Most typically, first workpiece 12 or similar workpieces are wooden boards, but may be other suitable material such as plastics and so forth.

Jig 10 includes a frame 16, an upper securing mechanism 18 mounted on frame 16, a lower workpiece-securing mechanism 20 mounted on frame 16 and a finger-mounting assembly 22 mounted on frame 16. Frame 16 has a front 24, a rear 26 in opposed relation to front 24, and a pair of opposed ends 28 and 30. Frame 16 has an axial direction extending between front 24 and rear 26 and is elongated in a longitudinal direction extending between opposed ends 28 and 30. Frame 16 also has a top 32 and a bottom 34 opposed thereto and adapted to sit atop a table or stand (not shown) to be mounted thereon. More particularly, jig 10 includes an upper wall 36 having a substantially flat upper surface 38 and a front wall 40 having a substantially flat front surface 42. A T-slot 44 is formed in front wall 40 and is open to front surface 42 and extends in a longitudinal direction over the entire length of front wall 40.

With continued referenced to FIG. 1, upper securing mechanism 18 includes a clamping member 46 in the form of an L-shaped angle iron having a generally horizontal leg 48 and a substantially vertical leg 50 extending upwardly from the front of leg 48. Clamping member 46 is vertically moveable between locked and unlocked positions with horizontal leg 48 securing a backup member 52 in the form of a board to upper surface 38 of frame 16 in the locked position. Clamping member 46 is elongated in the longitudinal direction. Securing mechanism 18 further includes a camming member 54 which is also elongated in the longitudinal direction and is disposed within the generally L-shaped channel formed by the L-shaped clamping member 46. Camming member 54 is rotatably mounted on a pair of mounting blocks 56 on either end of camming member 54. A handle 58 extends transversely from camming member 54. A pair of threaded members 60 extend respectively through a hole (not shown) formed in each mounting block 56 and a hole (not shown) in horizontal leg 48 of clamping member 46 and threadably engages a threaded hole (not shown) in upper wall 36 of frame 16. A handle or knob 62 is connected to an upper end of each threaded member 60 to facilitate rotation of threaded member 60. Each threaded member 60 also extends through a coil spring 64 disposed between upper surface 38 of frame 16 and horizontal leg 48 of clamping member 46 to bias clamping member 46 toward the unlocked position. Knobs 62 are rotated to rotate threaded members 60 to roughly or coarsely adjust the height of clamping member 46 and handle 58 facilitates rotation of camming member 54 which allows the quick clamping and release of backup member 52. More particularly, handle 58 and camming member 54 are rotated as indicated by Arrow B whereby a cam surface (not shown) on camming member 54 respectively engages or disengages horizontal leg 48 to provide a relatively fine adjustment in moving clamping member 46 between the locked and unlocked positions thereof.

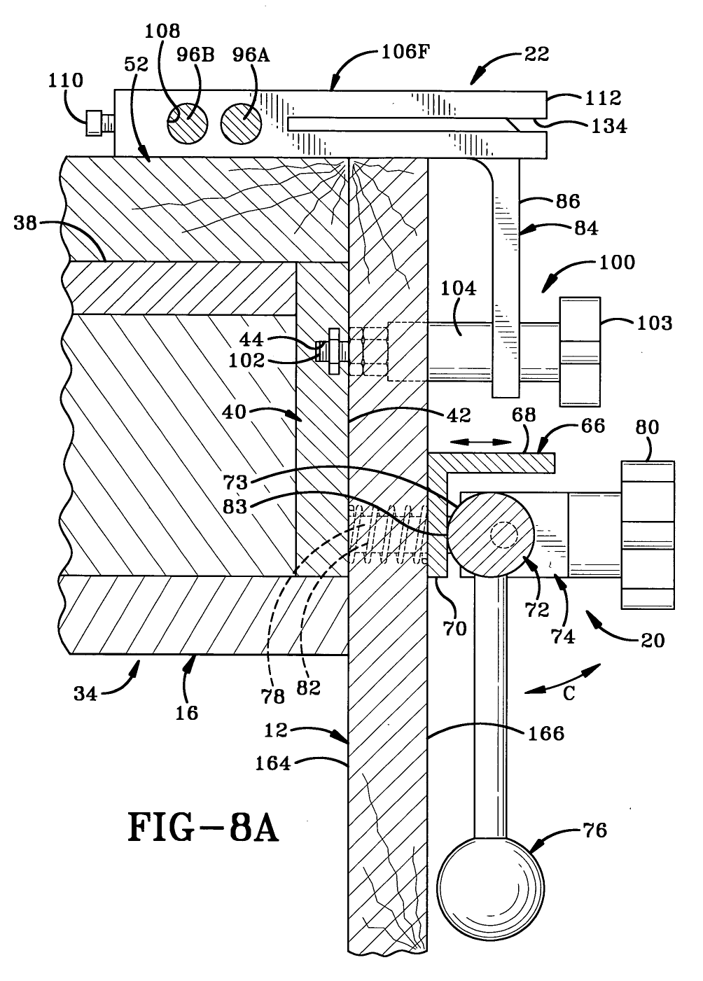

Lower securing mechanism 20 utilizes the same type of structure and functions in the same manner as upper securing mechanism 18 in order to secure workpiece 12 to front surface 42 of frame 16. Securing mechanism 20 includes a clamping member 66 in the form of an L-shaped angle iron having a horizontal leg 68 and a vertical leg 70 extending downwardly from a rear end of horizontal leg 68. Securing mechanism 20 further includes camming member 72 having a cam surface 73 (FIG. 8A). Camming member 72 is rotatably mounted on mounting blocks 74 with a handle 76 extending transversely from camming member 72. Leg 68 extends forward beyond camming member 72 (FIG. 8A) to completely cover member 72 as viewed from above. A pair of threaded members 78 similarly extend through respective holes (not shown) in mounting block 74 and vertical leg 70 of clamping member 66 and into a threaded hole (not shown) in front wall 40 of frame 16. Respective knobs 80 are connected to threaded members 78 and coil springs 82 are disposed between vertical leg 70 and front surface 42 to spring bias clamping member 66 in an unlocked position. As noted previously, lower securing mechanism 20 functions similarly to upper securing mechanism 46 except that clamping member 56 moves in a forward direction in the unlocked position and in a rearward direction to a locked position to secure workpiece 12 to frame 16. Knobs 80 and threaded members 78 provide the coarse adjustment while rotation of handle 76 and camming member 72 as shown by Arrow C moves cam surface 73 (FIG. 8A) to create a similar camming engagement 83 in order to provide a finer adjustment and quick locking and release of workpiece 12.

An important distinction between securing mechanism 20 and 46, and in accordance with a feature of the invention, clamping member 68 is configured to serve as a cover to prevent shavings from the cutting of workpiece 12 or other workpieces from interfering with the camming engagement (FIG. 8A) between camming member 72 and vertical leg 70 of clamping member 66.

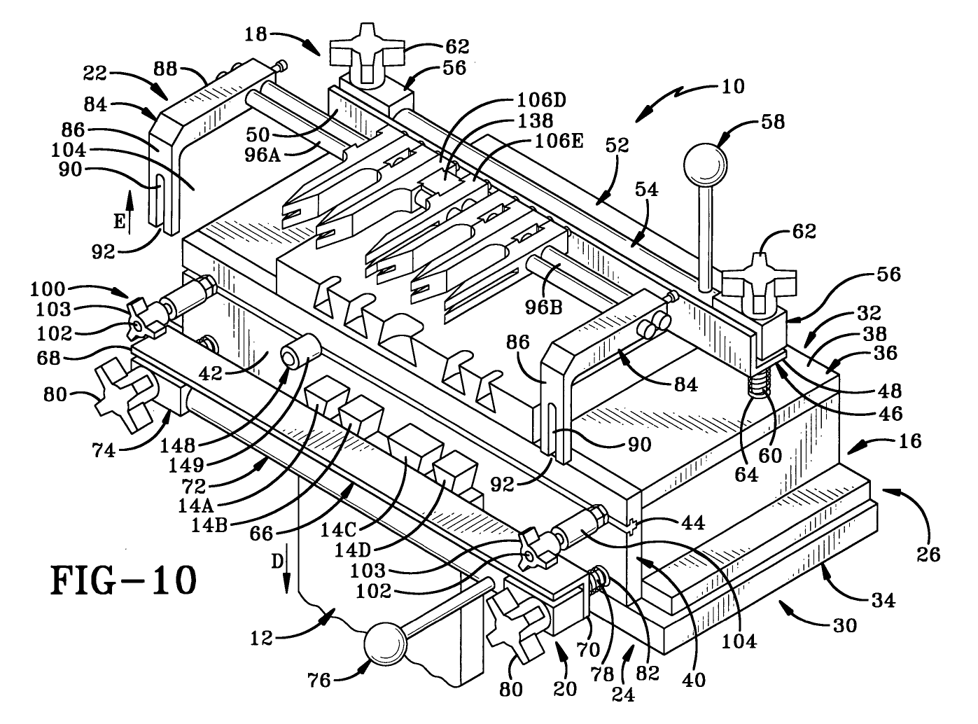

With continued reference to FIG. 1, finger-mounting assembly 22 is removably mounted on frame 16 in order to allow repositioning of assembly 22 as will be further detailed below. Assembly 22 includes a pair of spaced substantially L-shaped mounting members 84, one of which is mounted adjacent end 28 and the other of which is mounted adjacent end 30 of frame 16. Each mounting member 84 includes a substantially vertical lower leg 86 and a substantially horizontal upper leg 88 extending from an upper end of lower leg 86. Lower leg 86 defines an elongated vertically extending slot 90 having an open end 92 (FIG. 10). Each upper leg 88 defines a pair of longitudinally extending holes 94 for receiving a pair of guide members in the form of guide bars 96, in particular a front guide bar 96A and a rear guide bar 96B. Guide bars 96A and 96B extend parallel to one another in the longitudinal direction and are at substantially the same height. Guide bars 96A and 96B are each removably mounted within holes 94 of each mounting member 84. Rear guide bar 96B is secured to mounting member 84 by a threaded member 98 and front guide bar 96A is similarly secured by a threaded member (not shown).

A pair of mounting mechanisms 100 (FIG. 1) are connected to front wall 40 of frame 16 via T-slot 44 in a manner well known in the art. More particularly, each mounting mechanism 100 includes a threaded member 102 with a knob or handle 103 connected thereto adjacent a forward end thereof. Each mounting mechanism 100 further includes a spacer 104 in the form of a cylindrical collar which receives threaded member 102 and is slidable with respect thereto. Each threaded member 102 is received within one of slots 90 of mounting member 84 when finger-mounting assembly 22 is mounted on frame 16 via mounting mechanism 100.

A plurality of guide fingers 106 are mounted on guide bars 96A and 96B of assembly 22 so that they are selectively slidably movable along guide bars 96A and 96B. Guide fingers 106 are indicated more particularly as guide fingers 106A-106I in FIG. 1 for more detailed reference as discussed further below. Each guide finger 106 defines a pair of longitudinally extending holes 108 which respectively receive guide bars 96A and 96B. Each guide finger 106 is selectively secured to guide bar 96B via threaded member 110 which extends through a hole (not shown) of each guide finger 106 whereby threaded member is selectively engageable with guide bar 96B.

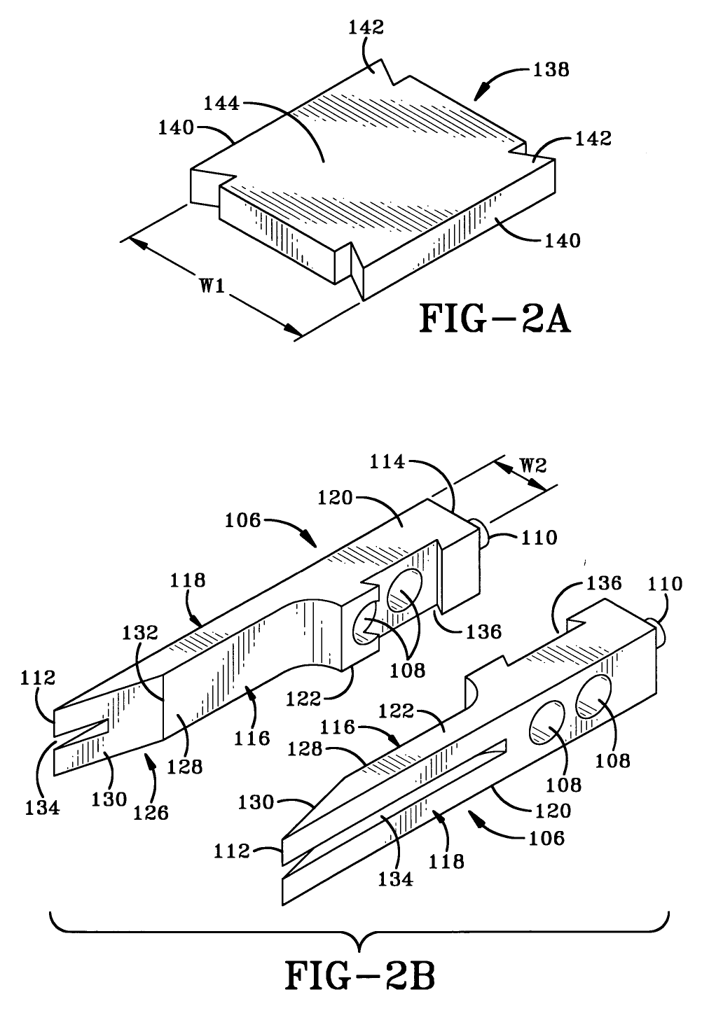

With reference to FIGS. 1 and 2B, guide fingers 106 are described in further detail. Each guide finger 106 has a first end 112, a second end 114 opposed thereto, a first side 116 and a second side 118 opposed thereto, an upper surface 120 and a lower surface 122. It is noted, however, that surface 122 of the finger 106 shown at the right in FIG. 2B is the upper surface when mounted on jig 10 as said finger is inverted with respect to the finger 106 shown on the left. Each finger is elongated between first end 112 and second end 114 and has a width W2 (FIG. 2B) extending from side 116 to side 118. Holes 108 extend from first side 116 to second side 118 and are adjacent second end 114. Each guide finger 106 when mounted on assembly 22 is connected to guide bars 96A and 96B at a connection site 124 (FIG. 1) and cantilevered forward therefrom. Fingers 106 are additionally supported by backup member 52. Each finger includes a narrowed projection portion 126 which extends from adjacent forward hole 108 to first end 112. Projection portion 126 includes a straight guide surface 128 and a tapered guide surface 130 on first side 116 of finger 106. Tapered guide surface 130 extends from first end 112 toward second end 114 and intersects straight guide surface 128 a tan intersection 132 and straight surface 128 extends from said intersection 132 towards second end 114. When mounted on frame 16 via assembly 22, each guide finger 106 extends in the axial direction of frame 16 with projection portion 126 extending forward of guide bars 96A and 96B so that some part of projecting portion 126 overhangs or extends forward of front surface 42 of front wall 40. When so mounted, straight surface 128 extends in the axial direction of frame 16 perpendicular to guide bars 96A and 96B and also to flat front surface 42 of front wall 40.

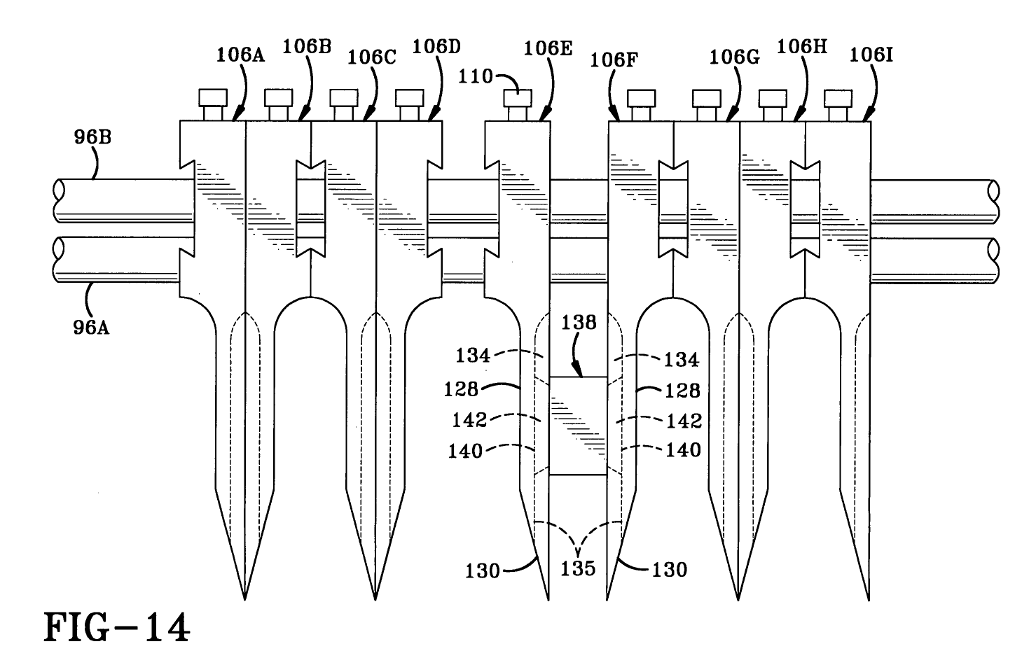

A first slot 134 is formed in projecting portion 126 of each guide finger 106 and extends from first end 112 toward second end 114. Each first slot 134 is substantially parallel to and centrally located between upper surface 120 and lower surface 122. Each slot 134 extends inwardly from second side 118 of finger 106 to an axially elongated spacing surface 135 (FIG. 14) which is parallel to first side 116 and second side 118 of finger 106. Thus, when fingers 106 are mounted on frame 16, slots 134 extend in the axial direction and are substantially horizontal. A second slot 136 having a dovetail shape as viewed from above is formed in each guide finger 106 adjacent second end 114 and extends inwardly from first side 116 of finger 106 and downwardly from upper surface 120 to lower surface 122. Rearward hole 108 intersects second slot 136 and a portion of the front hole 108 intersects second slot 136. Guide fingers 106 are bilaterally symmetrical with respect to a plane parallel to upper and lower surfaces 120 and 122 and therefore may be used in a first position as indicated by the finger 106 in the left of FIG. 2B or in an inverted position as indicated by the finger 106 in the right of FIG. 2B. As can be seen from FIGS. 1 and 2B, fingers 106 are generally used in pairs in order to make the cuts in various workpieces as will be discussed further below. Fingers 106 may be paired as indicated in FIG. 2B with guide surfaces 128 and 130 facing one another. Alternately, they may be thought of as being paired with respective second sides 118 facing one another.

In accordance with a feature of the invention and with reference to FIGS. 1 and 2A, jig 10 further includes a specially configured spacer 138 which is insertable in a pair of adjacent second slots of a respective pair of adjacent fingers 106 in order to set the spacing between said pair of fingers 106. In particular, spacer 138 is a flat plate-like structure having a pair of opposed edges 140 defining therebetween a width W1 (FIG. 2A). Adjacent each edge 140, spacer 138 includes a dovetail-shaped structure 142 which serves as an interlocking portion or a key having a mating configuration with second slot 136 of each finger 106. Each dovetail structure 142 extends in opposed directions from a central portion 144 of spacer 138. The width W1 of spacer 138 may vary in accordance with the desired spacing to be set between an adjacent pair of fingers 106. Preferably jig 10 includes spacers 138 having various widths for spacing guide fingers at commonly desireable positions.

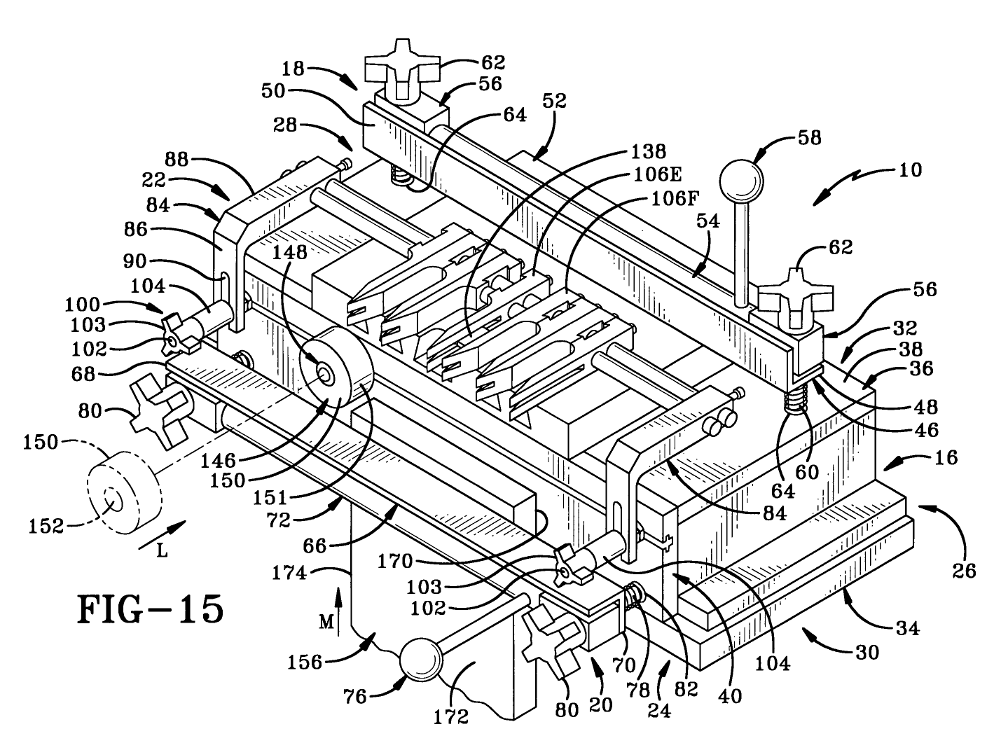

In accordance with another feature of the invention, jig 10 also includes a multi-position stop 146 (FIG. 15) including a first stop member 148 in the form of a cylindrical post (FIG. 1) and an annular second stop member 150 which is substantially cylindrical and defines a cylindrical hole 152 for receiving first stop member 148 whereby second stop member 150 is slidably mountable and removable from first stop member 148. First stop member 148 has a positioning edge 149 which lies on a cylindrical outer surface thereof and which is disposed at a first location. Second stop member 150 has a positioning edge 151 (FIG. 15) which lies on a cylindrical outer surface thereof and which is disposed at a second location. The cylindrical outer surface of first and second stop members 148 and 150 are concentric. First stop member 148 is mounted via a threaded member 154 to front wall 140 of frame 16 via T-slot 44.

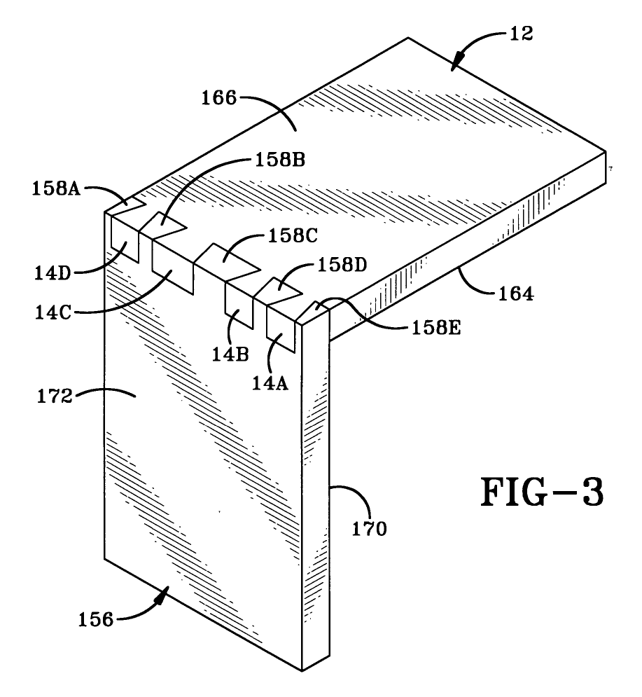

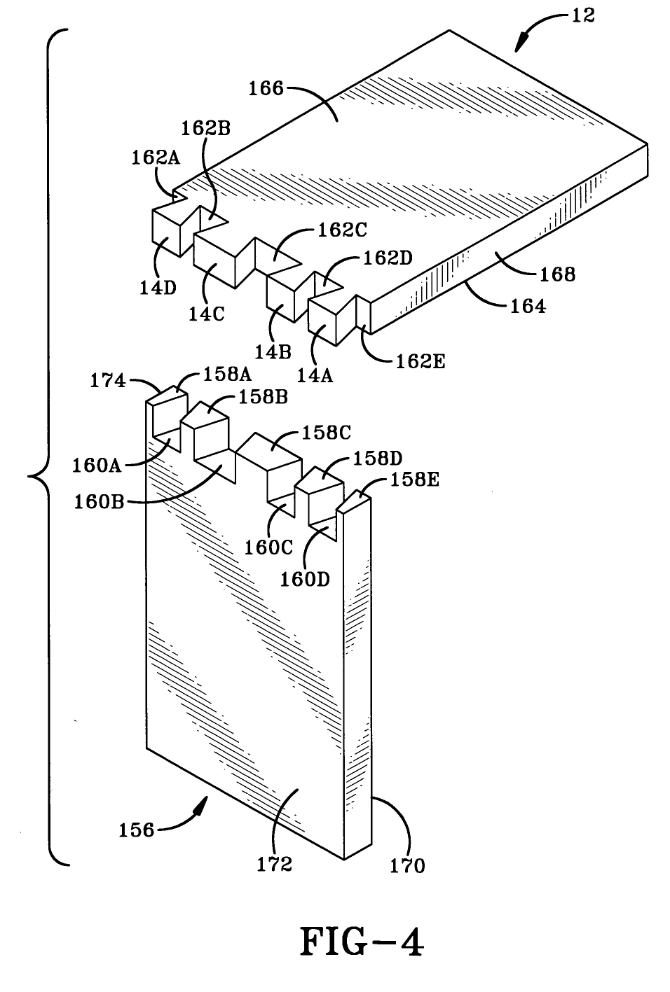

As previously noted, jig 10 is used in the cutting of first workpiece 12 to form dovetails 14 and a second workpiece 156 to form pins 158A-E which mate with respective dovetails 14 of first workpiece 12 to form a dovetail joint (FIGS. 3-4). More particularly, with regard to pins 158, pins 158A and 158E are actually half pins. Pins and half pins 158A-158E define respectively therebetween sockets 160A-160D (FIG. 4). First workpiece 12 defines sockets 162A-162E with 162A and 162E more particularly being half sockets. Workpiece 12 has a frame side 164, a clamping side 166 opposed thereto and a stop edge 168 extending therebetween. Likewise, workpiece 156 has a frame side 170, a clamp side 172 opposed thereto and a stop edge 174 extending therebetween. Of course workpieces 12 and 156 can be arranged in various orientations when used with jig 10, but these references will simplify later explanation.

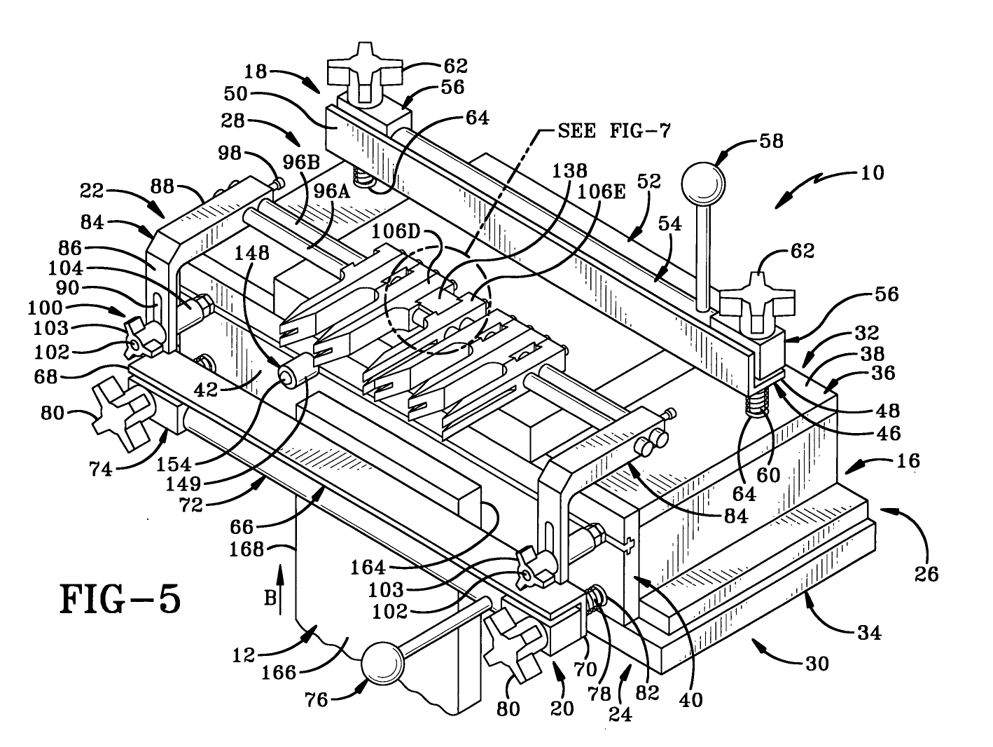

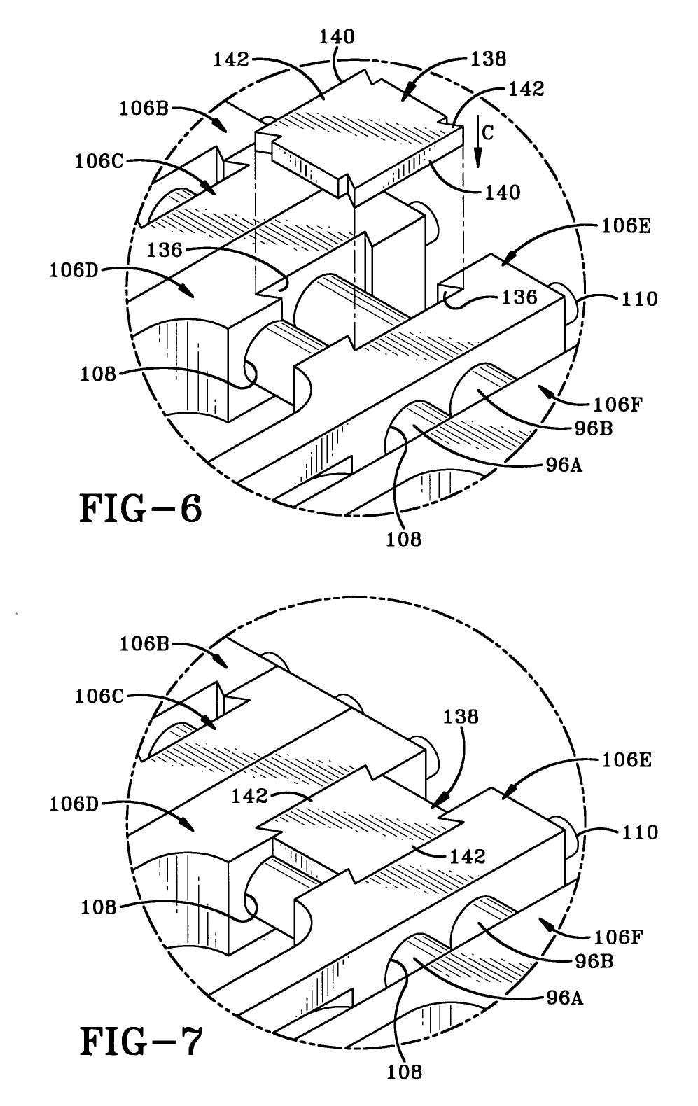

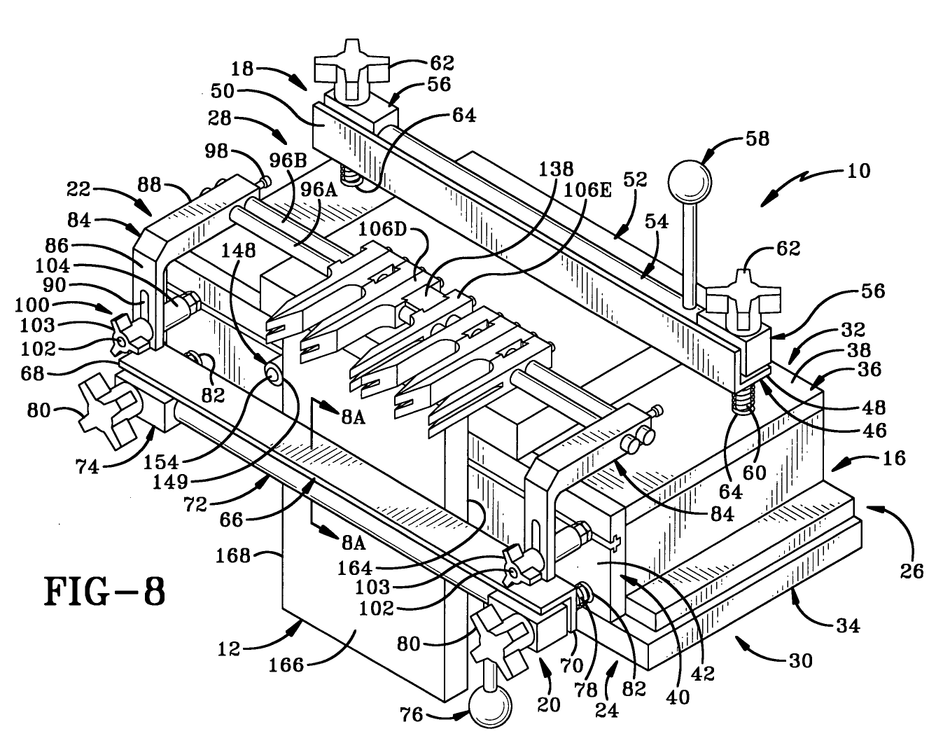

The operation of jig 10 is now described with reference to FIGS. 5-18. With reference to FIG. 5, first workpiece 12 is moved upwardly as indicated by Arrow B to position workpiece 12 between front surface 42 and vertical leg 70 of clamping member 66 with frame side 164 adjacent front surface 42 and clamp side 166 adjacent vertical leg 70. Lower securing mechanism 20 remains in the unlocked position. Prior or subsequent to securing workpiece 12 in position, upper securing mechanism 18 is adjusted to the locked position to secure backup member 52 with clamping member 46 against upper surface 38 of frame 16. With reference to FIGS. 5-7, spacer 138 is lowered in a substantially horizontal orientation into position in a downward insertion direction as indicated by Arrow C in FIG. 6 so that dovetail structures 142 slide into position within respective second slots 136 of a pair of adjacent guide fingers 106D and 106E. Due to the mating interlocking configuration of second slots 136 and respective dovetail structure 142, an interlocking fit between spacer 138 and each finger 106D and 106E automatically locks guide fingers 106D and 106E in fixed relation with respect to one another and sets a given spacing between this pair of adjacent guide fingers. In particular, spacer 138 sets the spacing between the respective straight surfaces 128 of guide fingers 106D and 106E as well as the spacing between respective tapered surfaces 130 of guide fingers 106D and 106E.

With continued reference to FIG. 5, the spacing between the other guide fingers 106 is set as desired, with or without a spacer like spacer 138, to ultimately provide desired sizes of dovetails on workpiece 12 once cut by an appropriate cutter blade. The longitudinal positioning of guide fingers 106 is set with respect to positioning edge 149 of first stop member 148. Although the spacing between the various guide fingers 106 may vary as desired, the figures indicate that fingers 106A-D are in contact with one another in sequence. As already noted, fingers 106D and 106E are spaced by spacer 138. Guide fingers 106E and 106F are spaced from one another with no spacers setting the space therebetween and guide fingers 106E-I are respectively in contact with one another. It is also noted that guide fingers 106 are alternately in the first position and the inverted position so as to form pairs as previously discussed. Mounting assembly 22 is mounted in a first position with lower vertical legs 86 of respective mounting members 84 positioned forward of respective spacers 104 with threaded members 102 tightened with handle 104 to secure assembly 22 in the first position. As a result, guide fingers 106 are in a first axially oriented position with straight guide surfaces 128 extending forward of front surface 42 of front wall 40.

More particularly and with reference to FIG. 8, once workpiece 12 is properly positioned, straight guide surfaces 128 are disposed directly above workpiece 12 with tapered guide surfaces 130 extending forward of clamp side 166 of workpiece 12. As seen in FIG. 8, workpiece 12 is positioned at a first workpiece location with stop edge 168 against positioning edge 149 of first stop member 148 so that the overall spacing of guide fingers 106 is properly set with respect to workpiece 12. Lower securing mechanism 20 is operated to move to the locked position so that workpiece 12 is secured by clamping member 66 against front surface 42 of front wall 40. More particularly and with reference to FIG. 8A, handle 76 is rotated as indicated by Arrow C so that camming member 72 moves clamping member 70 into the locked position via the camming engagement 83 between the two members 70 and 72, which is, as previously noted protected from shavings by member 70 serving as a cover. Workpiece 12 is now ready to be cut by a cutting mechanism to form dovetails 14.

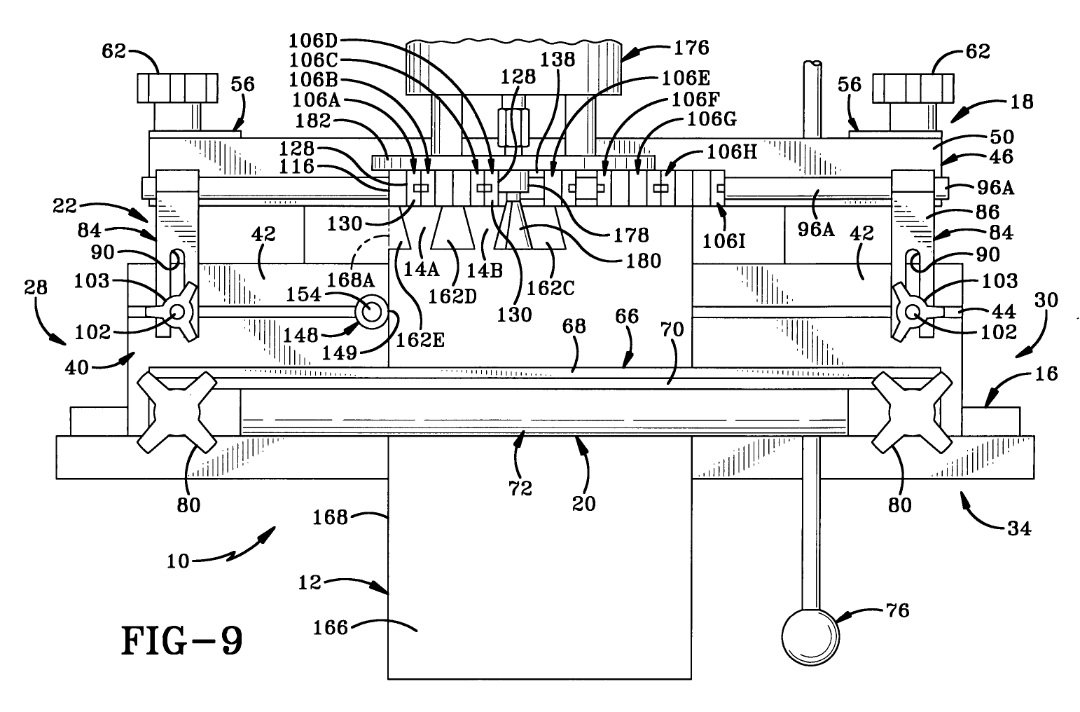

As indicated in FIG. 9 by dashed line 168A, positioning edge 149 of first stop member 148 aligns stop edge 168 with the portion of first side 116 of guide finger 106A which is disposed furthest to the left. FIG. 9 shows in fragmentary a router 176 having a guide sleeve 178 with a tapered cutter bit 180 extending therefrom. Router 176 further includes a base 182 which is seated atop guide fingers 106. Cutter bit 180 has already cut half socket 162E and socket 162D and is in the process of cutting socket 162C. In particular, guide sleeve 178 follows respective straight guide surfaces 128 of fingers 106 in order to cut said sockets 162. More particularly, half socket 162E was cut by guiding sleeve 178 along straight guide surface 128 of guide finger 106A, socket 162D was cut by guiding guide sleeve 178 along straight surfaces 128 of guide fingers 106B and 106C and so forth. Thus, once the cutting of workpiece 12 is complete, the straight guide surfaces 128 of guide fingers 106D and 106E will have been used for the cutting of socket 162C, straight guide surfaces 128 of guide fingers 106F and 106G will have been used to cut socket 162D and straight guide surface 128 of finger 106H will have been used to cut half socket 162E. Thus, guide finger 106I is not used in the cutting of any sockets 162 for workpiece 12. As detailed below, guide finger 106I is however used in the cutting of second workpiece 156.

Once tapered cutter bit 180 has cut all of sockets 162 in workpiece 12 to form dovetails 14, handle 76 of lower securing mechanism 20 is rotated to the unlocked position and knobs 80 are unscrewed to allow workpiece 12 to be removed as indicated by Arrow D in FIG. 10. FIG. 10 also shows that cutter bit 180 made cuts into backup board 52 during the process of cutting sockets 162 in workpiece 12. After removing workpiece 12, knobs 103 are turned along with threaded member 102 to loosen mounting mechanism 100 so that finger-mounting assembly 22 may be removed as shown by Arrow E in FIG. 10.

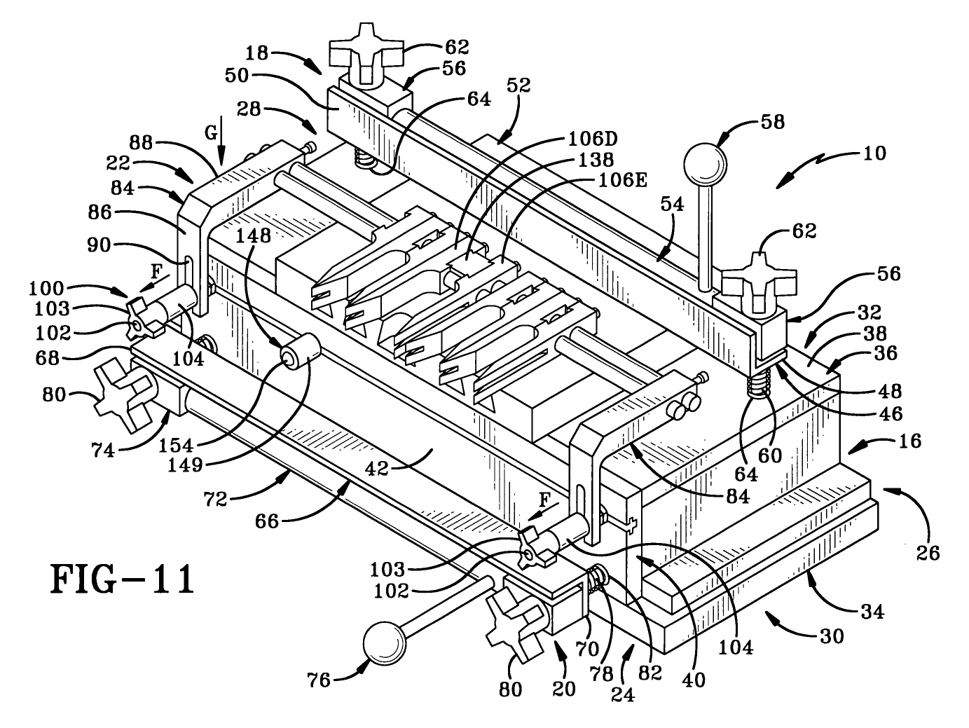

FIG. 11 shows that spacers 104 of mounting mechanism 100 are then moved forward as indicated by Arrows F to a second position so that mounting assembly 22 with fingers 106 can be moved rearwardly to a second axially oriented position by the lowering of assembly 22 as indicated by Arrow G with slot 90 of lower vertical leg 86 receiving threaded member 102 of mounting mechanism 100. In the second position, fingers 106 are moved rearwardly in the axial direction of frame 16 so that only tapered guide surfaces 130 of fingers 106 extend forward of front surface 42 of front wall 40. Moving assembly 22 to this second position is in preparation for the cutting of sockets 160 in second workpiece 156.

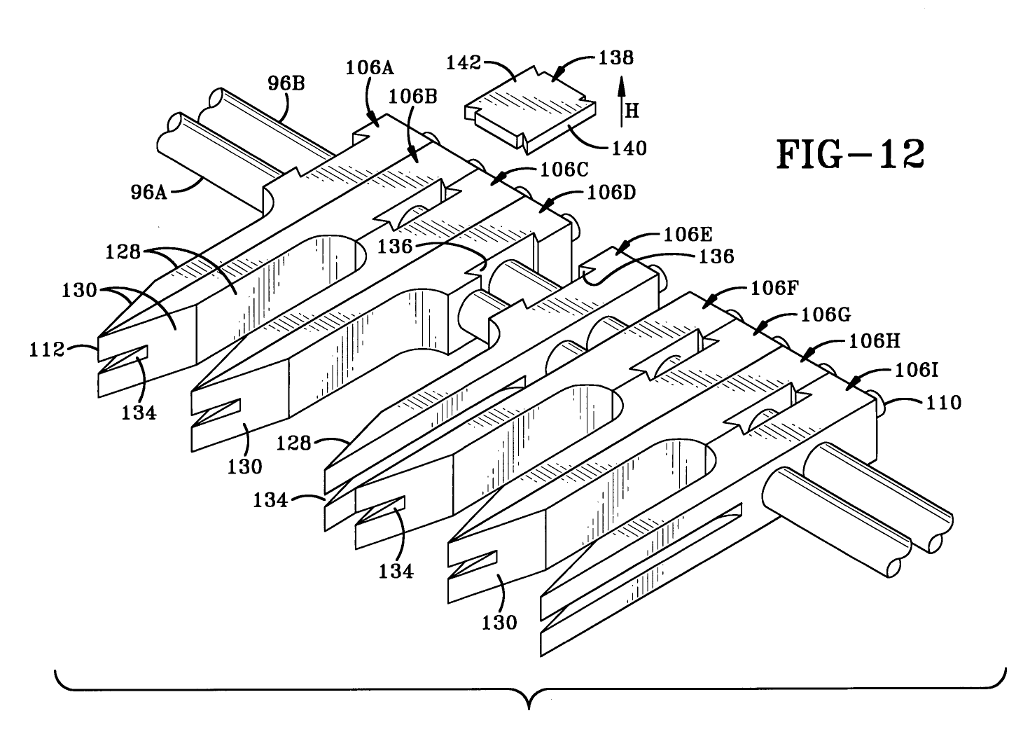

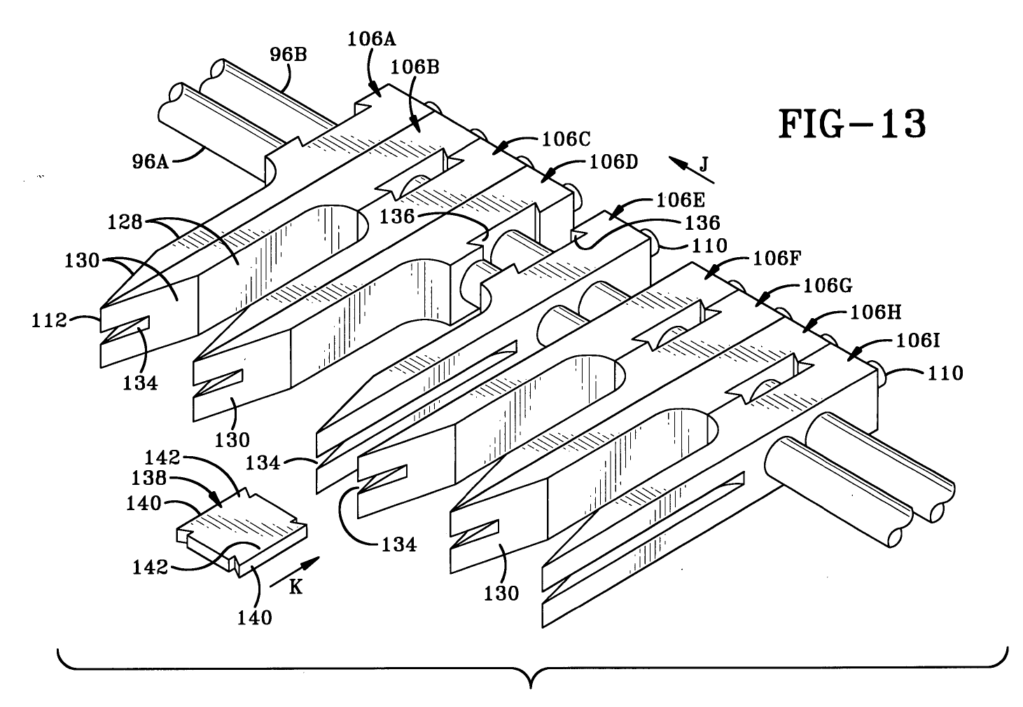

FIG. 12 shows spacer 138 being removed from the respective second slots 136 of the pair of adjacent guide fingers 106D and 106E as indicated by Arrow H. FIG. 13 shows finger 106E being moved in a longitudinal direction toward finger 106D as indicated by Arrow J after loosening the respective threaded member 110 and subsequently horizontally oriented spacer 138 being inserted in a rearward, substantially horizontal insertion direction as indicated by Arrow K into the respective first slots 134 of a second pair of adjacent guide fingers 106E and 106F so as to set the spacing between fingers 106E and 106F. Once spacer 138 has been inserted in first slots 134, threaded member 110 of finger 106E is tightened to secure finger 106E to guide bar 96B to secure the position of guide finger 106E. FIG. 14 shows spacer 138 inserted in the first slots 134 of fingers 106E and 106F with dovetail portions 142 disposed within said slots 134 and edges 140 abutting respective spacing surfaces 135. Neither of guide fingers 106D or 106F were moved in establishing the new spacing between finger 106D and 106E and between fingers 106E and 106F.

It is noted that while the use of only one spacer 138 has been described for simplicity, a plurality of spacers 138 may be used in the same manner to set the spacing between respective adjacent pairs of guide fingers 106. Each spacer 138 used between a given set of guide fingers 106 may be of a different width W1 (FIG. 2A) if desired to create the desired size of dovetails and pins of the finished joint between workpieces 12 and 156. Thus, for example, another spacer 138 may have been initially inserted in the respective second slots 136 between fingers 106F and 106G to set the spacing therebetween for the cutting of workpiece 12. Then, as described in the previous paragraph, the additional spacer 138 would be removed, finger 106G, which would have been spaced from finger 106F by the additional spacer 138, would be moved toward finger 106F and the additional spacer 138 would be inserted in the respective first slots 134 of fingers 106G and 106H.

Once finger 106E has been repositioned and with reference to FIG. 15, second stop member 150 is moved as shown by Arrow L onto first stop member 148 which is received within hole 152 of second stop member 150. The addition of second stop member 150 creates a second workpiece location for workpiece 156 via positioning edge 151 of member 150. Once second stop member 150 is in place, second workpiece 156 is moved as indicated by Arrow M between clamping member 66 and front surface 42 of front wall 40.

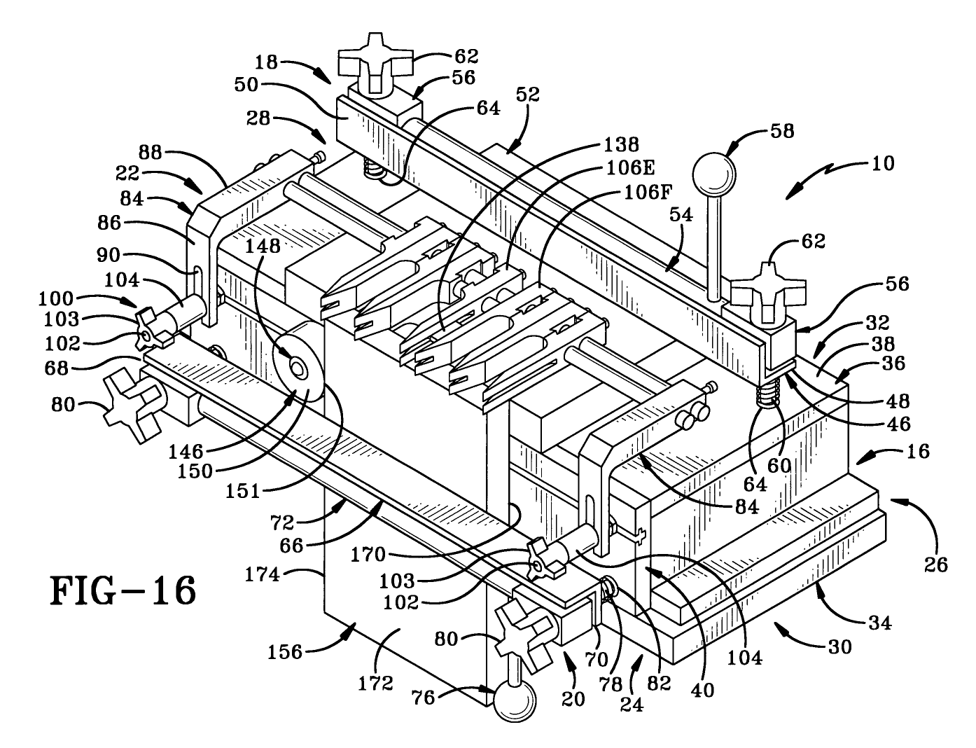

FIG. 16 shows workpiece 156 in the second workpiece location with stop edge 174 abutting positioning edge 151 of second stop member 150 and an upper end of workpiece 156 abutting guide fingers 106. Clamp side 172 faces forward and frame side 170 faces rearwardly. Lower securing mechanism 20 has been moved into the locked position via the adjustment of knobs 80 and the rotation of handle 76 to secure workpiece 156 against front surface 42 so that workpiece 156 is ready to be cut.

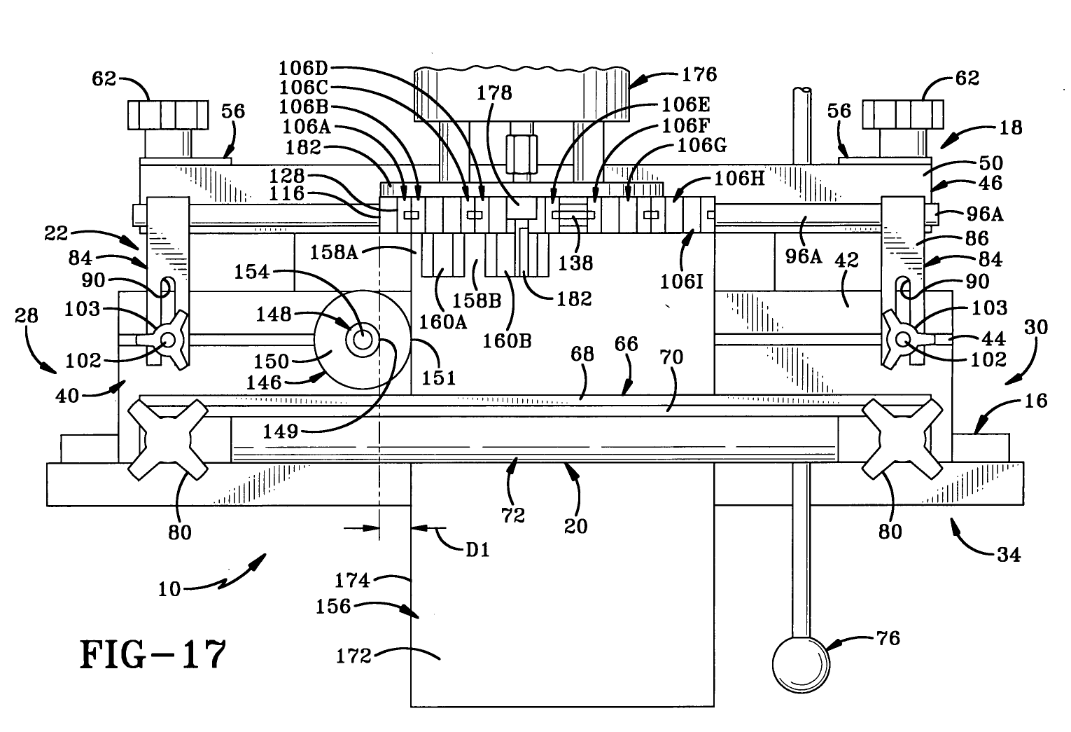

As seen in FIG. 17, the addition of second stop member 150 creates the second workpiece location for second workpiece 156 a longitudinal distance D1 from the first workpiece location (FIG. 8) established by positioning edge 149 of first stop member 148. Distance D1 is equal to width W1 (FIG. 2B) of a guide finger 106, which is equal to the thickness of annular second stop member 150 from the inner surface bounding hole 152 thereof to positioning edge 151.

The repositioning of the workpiece location by the use of positioning edge 151 of stop member 150 ultimately positions workpiece 156 in the longitudinal direction with respect to fingers 106 so that sockets 160 will be cut in the proper place to allow proper alignment of the dovetails 14 and pins 158 to form the dovetail joint (FIG. 3). As shown in FIG. 17, router 176 is again positioned with base 182 atop fingers 106 although this time a straight cutter bit 182 is used in order to cut sockets 160 in the formation of pins 158. As seen in FIG. 17, the cutting of sockets 160 does not include the use of guide finger 106A. FIG. 17 shows socket 160A having been cut by cutter bit 182 as guide sleeve 178 moved along tapered guide surfaces 130 of guide fingers 106B and 106C. FIG. 17 also shows cutter bit 182 in the process of cutting socket 160B with guide sleeve 178 having been guided along tapered surfaces 130 of guide fingers 106D and 106E. Once completed, socket 160C will have been cut using tapered surfaces 130 of guide fingers 106F and 106G and socket 160D will have been cut by cutter bit 182 using tapered surfaces 130 of guide fingers 106H and 106I.

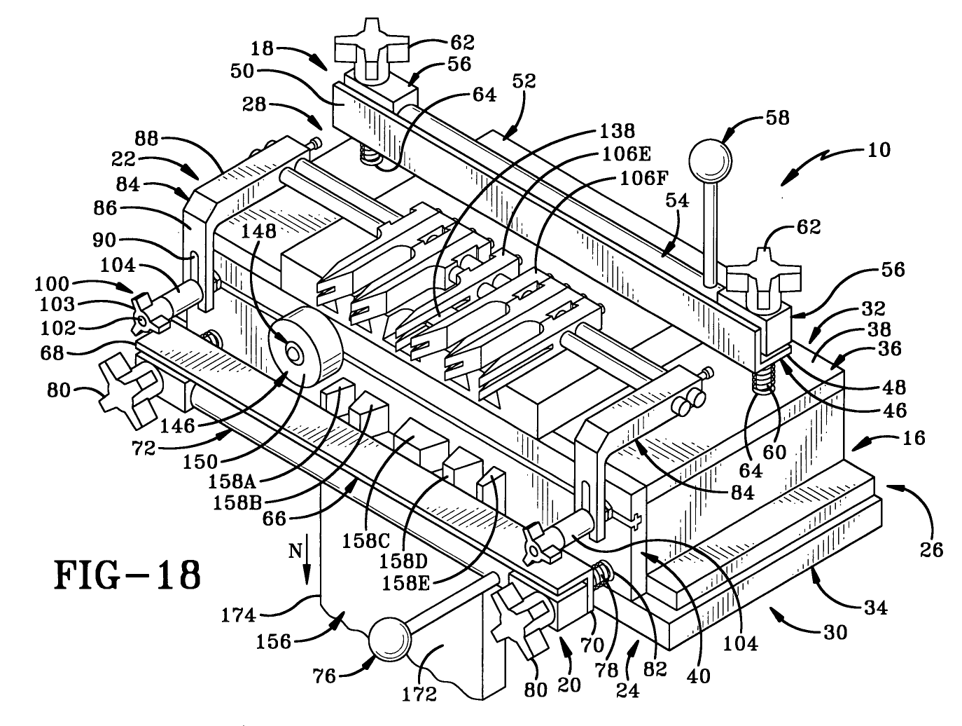

As seen in FIG. 18, said sockets 160A-106D have been cut in workpiece 156 to form pins 158A-158E. At this stage, all the cutting to form the dovetail joint is completed. Thus, lower securing mechanism 20 is operated via knobs 80 and handle 76 to move to the unlocked position and workpiece 156 is removed as indicated by Arrow N. Thus, jig 10 provides several unique, simple and cost-effective features which overcome the problems discussed in the Background of the present application.

It is noted that the method of using jig 10 has been described regarding first workpiece 12 to form dovetails 14 and then cutting second workpiece 156 to form pins 158. As previously noted, the cutting of the first workpiece to form the dovetails was achieved by guiding the cutter along the straight parallel edges of the guide fingers while the cutting of the second workpiece to form the dovetails was achieved by guiding the cutter along the tapered edges of the guide fingers. In conjunction with this order of the process, the second stop member 150 was positioned over the first stop member 148 to move the workpiece location away from the first stop member 148 or generally in the right as viewed in the drawings. Thus, the second workpiece is positioned in a first longitudinal direction with respect to the first workpiece location while the spacer 138 is also moved in this first direction during the process of changing the location of the guide fingers to change from the first workpiece cutting configuration to the second workpiece cutting configuration. During this switch-over process, the guide finger which is moved in conjunction with the movement of spacer 138 from the second slots to the first slots moves in a longitudinal direction opposite that of the movement of spacer 138 and the workpiece location. The multi-position stop 146 is thus used to create a second positioning surface which is longitudinally in the first direction with respect to the first workpiece positioning surface. As shown in FIGS. 10 and 11, finger-mounting assembly 22 is moved axially in order to change the guide surfaces being utilized, in particular, moving guide fingers 106 from a position where the straight surfaces are used in the cutting of the first workpiece and the tapered surfaces are used in the cutting of the second workpiece. As will be evident to one skilled in the art, it is further noted that this process could be generally reversed whereby the second workpiece is cut first using the tapered surfaces in order to cut the pins and the first workpiece is cut second using the straight surfaces to cut the dovetails. This reversal of the procedure would thus change the direction of movement with regard to the various items discussed above in this paragraph, such as the location of the workpieces, the movement of the spacer and movement of the finger when switching between the first workpiece cutting configuration and the second workpiece cutting configuration.

As will be appreciated by those skilled in the art, a variety of changes may be made to jig 10 which are within the scope of the invention. For instance, stop 146 (FIG. 15) can take a number of configurations which set first and second workpiece locations with first and second stop members. First and second stop members need not have cylindrical outer surfaces and may simply be a pair of stop members which are selectively positionable adjacent one another on the frame. Most preferably, the second stop member is in contact with the first stop member when positioned adjacent thereto and more preferably defines an opening for receiving some portion of the first stop member. While second stop member 150 includes a through hole 152 allowing it to be mounted on the first stop member with either side of second stop member 150 facing the frame of the jig is not necessary for the hole to extend all the way through second stop member. However, the annular or doughnut-shape of second stop member 150 simplifies the mechanism so that no particular measurement or alignment is required in order to change jig 10 from the first position for a first workpiece to the second position for a second workpiece. Second stop member 150 simply slides onto first stop member 148 and regardless of the orientation of stop member 150 always provides positioning edge 151 in the same location.

In addition, different configurations of guide fingers and corresponding spacers may be provided while still providing the central functions described herein. It is noted that the slots formed in fingers 106 may have different configurations. With respect to second slots 136, different shaped slots may be formed with a mating configuration of spacer 138 whereby a spacer analogous to spacer 138 interlocks with a pair of adjacent guide fingers to fix the relationship between the two and thereby set the spacing therebetween. In addition, first slots 134 may be configured differently as well. For instance, analogous first slots could be defined in fingers 106 whereby a spacer analogous to spacer 138 may be received downwardly as is the case with the use of spacer 138 in second slots 136 instead of entering slots from a forward position by moving in a substantially horizontal direction. Further, dovetail slots or similar interlocking configurations may be formed as an alternate to first slots 134 to automatically fix an adjacent pair of guide fingers as demonstrated via second slots 136. While first slots 134 may be replaced with slots which are adjacent second end 114 of fingers 106, it is preferred to have a spacer disposed closer to tapered guide surfaces 130 in order to provide more substantial support between the pair of fingers which are spaced by the spacer.

This is particularly true with the type of fingers described herein because the projection portions 126 are longer than the projection portions of guide fingers which extend respectively in opposite directions from a connection site with guide surfaces on both sides of the connection site. Obviously, projection portions 126 are relatively longer than such other fingers due to the combination of having straight guide surfaces and tapered guide surfaces on a single projection portion extending generally in one direction. While of course fingers 106 may be wider or thicker in various dimensions in order to provide a stronger projection portion so that the positioning of a spacer between the projection portions is less critical, this would of course increase the amount of material required to produce guide fingers such as guide fingers 106 and may inhibit the ability to form smaller sized dovetails, pins or other joint members. Due to the extra length of projection portions 126, it is noted that it is preferable for the guide fingers which are not spaced by spacers such as spacers 138 to be in abutment with one another to provide additional strength to the projection portions, especially the tapered guide surfaces 130 which extend furthest from the connection site.

In addition, guide fingers and corresponding spacers may be formed without the use of slots in the guide fingers. For instance, guide fingers could alternately be formed with holes or openings therein into which a portion of a spacer could extend to fix the longitudinal relationship between a pair of adjacent guide fingers. One example of this type of configuration would be guide fingers having non-cylindrical holes extending downwardly therein with a spacer having a pair of extensions with a mating cross-sectional configuration with the respective holes whereby the extensions fit into the holes in an analogous way to the dovetail structures fitting into the slots of the embodiment shown in the figures of the present invention. Alternately, guide fingers could be formed with posts or other projections extending outwardly therefrom to fit into holes or slots formed in a spacer. Other analogous configurations will be evident to one skilled in the art. A variety of other changes would be apparent to those skilled in the art and are within the scope of the present invention.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A jig used for cutting joint members in workpieces, comprising:
a frame having axial and longitudinal directions and adapted to selectively secure the workpieces to be cut;
a plurality of guide fingers elongated in the axial direction; each guide finger having guide surfaces adapted to guide a cutter in the formation of the joint members; the guide fingers being selectively positionable in the longitudinal direction; and
a spacer selectively mountable on a first pair of adjacent fingers to selectively fix the adjacent fingers in the longitudinal direction with respect to one another, thereby setting longitudinal spacing between the first and second fingers.

2. The jig of claim 1 wherein the spacer forms an interlocking engagement with each of the first pair of adjacent guide fingers when mounted thereon.

3. The jig of claim 2 wherein each of the first pair of adjacent fingers defines a first slot in which a portion of the spacer is selectively receivable to form each respective interlocking engagement.

4. The jig of claim 3 wherein the first pair of fingers each have an upper surface; and wherein the first slots extend downwardly from the respective upper surfaces whereby the spacer is inserted into the respective first slots in a downward insertion direction.

5. The jig of claim 3 wherein each guide finger has a second slot formed therein whereby the respective second slots of a second pair of adjacent guide fingers are aligned with one another to receive a spacer therein to set longitudinal spacing between the second pair of adjacent guide fingers.

6. The jig of claim 5 wherein each guide finger is mounted on the frame at a connection site; wherein each guide finger has a projection portion which is cantilevered from the connection site and which has straight and tapered guide surfaces thereon respectively adapted to guide the cutter in the respective formation of dovetails and pins; and wherein each second slot is formed in the projection portion.

7. The jig of claim 6 wherein first and second guide fingers form the first pair of adjacent guide fingers; wherein the second guide finger and a third guide finger form the second pair of adjacent guide fingers; and wherein the spacing set between the first pair of adjacent guide fingers is associated with use of the straight guide surfaces; and wherein spacing alternately set between the second pair of guide fingers is associated with use of the tapered guide surfaces.

8. The jig of claim 7 wherein the spacer which is receivable in the respective first slots of the first and second fingers is alternately receivable in the respective second slots of the second and third fingers.

9. The jig of claim 8 wherein alternately receiving the spacer in the respective second slots of the second and third fingers to set the spacing therebetween is achievable by repositioning the second guide finger without repositioning the first and third guide fingers.

10. The jig of claim 3 wherein each finger is mounted on the frame at a connection site; and wherein the first slot is situated above the connection site.

11. The jig of claim 1 further including a stop comprising a first stop member having a first positioning surface positionable at a first location and adapted for positioning one of the first and second workpieces and a second stop member having a second positioning surface positionable at a second location and adapted for positioning the other of the first and second workpieces.

12. The jig of claim 11 wherein the second stop member defines a hole in which the first stop member is selectively receivable to mount the second stop member on the first stop member.

13. The jig of claim 1 wherein a workpiece-securing mechanism is mounted on the frame and includes an elongated clamping member adapted for clamping a workpiece to the frame and an elongated camming member having a cam surface engageable with the clamping member for selectively moving the clamping member in a tightening direction; wherein the clamping member serves as a cover adapted to prevent workpiece shavings from interfering with the engagement between the cam surface and the clamping member; and wherein the clamping member includes a rear clamping portion with a workpiece-engaging surface facing the frame and a top portion connected to and extending from the rear clamping portion away from the frame and over the camming member.

14. The jig of claim 13 wherein the clamping member in cross section is L-shaped.

15. A method comprising the steps of:
securing a first workpiece to a frame having axial and longitudinal directions;
positioning a plurality of axially-elongated guide fingers in the longitudinal direction;
fixing a first adjacent pair of the guide fingers in the longitudinal direction with respect to one another with a spacer, the first adjacent pair including first and second guide fingers;
securing the plurality of guide fingers with respect to the frame; and
guiding a cutter with the guide fingers to cut the first workpiece.

16. The method of claim 15 wherein the step of fixing includes the step of inserting the spacer into a pair of first slots formed respectively in the first and second guide fingers.

17. The method of claim 16 wherein the step of inserting includes the step of interlocking the spacer with each of the first and second guide fingers.

18. The method of claim 15 further including the steps of removing the first workpiece from the frame; securing a second workpiece to the frame; removing the spacer from the first slots; repositioning the second guide finger in the longitudinal direction; inserting the spacer into a pair of second slots one of which is formed in the second guide finger and the other of which is formed in a third guide finger disposed adjacent the second guide finger opposite the first guide finger in the longitudinal direction; and guiding the cutter with the guide fingers to cut the second workpiece.

19. The method of claim 18 further including the steps of placing the first workpiece against a first stop member to position the first workpiece at a first workpiece location; and placing the second workpiece against a second stop member to position the second workpiece at a second workpiece location which is longitudinally spaced from the first workpiece location.

20. The method of claim 19 further including the step of mounting the second stop member on the first stop member prior to the step of placing the second workpiece against the second stop member.
